(19) United States
(12) Patent Application Publication
(10) Pub. No.: US 2006/0272372 A1
(43) Pub. Date: Dec. 7, 2006

(54) Cylinder lock and associated key

(75) Inventors: Enzo Talamonti, Ascoli Piceno (IT); Fausto Fustini, Imola (IT)

Correspondence Address: MODIANO & ASSOCIATI, Via Meravigli, 16, Milan, 20123, IT

(73) Assignee: CISA S.P.A.

(21) Appl. No.: 11/304,604

(22) Filed: Dec. 16, 2005

(30) Foreign Application Priority Data
Jun. 1, 2005 (IT) BO2005A000381

(51) Int. Cl. E05B 27/06; E05B 19/06

(52) U.S. Cl. 70/358; 70/409

(57) ABSTRACT

A cylinder lock and key comprising primary pins which are mutually opposite with respect to a longitudinal slot provided in the rotor of the cylinder for insertion of the key; the primary pins are associated with respective movable complementary pins accommodated within respective passages of the rotor and the stator, provided at the surface of discontinuity formed between the stator and the rotor of the cylinder. The key has a seat for accommodating a respective orientable lever, that actuates the primary pins aligned with it: the lever has a thickness variable, even locally and discontinuously, according to a coded pattern, depending on geometry and arrangement of the primary pins, forming a particular configuration of contact of the heads of the primary pins against the surface of the lever at which the complementary pins are completely accommodated within only one of the passages.

The present invention relates to a cylinder lock and to the associated key.

### BACKGROUND OF THE INVENTION

Currently there exists a cylinder lock which can be operated by means of a respective key, the characteristics of which are disclosed in Industrial Invention Patent No. 1235586 dated 6 Sep. 1989 in the name of the same Applicant. This document discloses a cylinder lock the code of which cannot be decoded straightforwardly from outside, in order to hinder tampering therewith.

This result is achieved by arranging at least two primary pins which are mutually opposite, with respect to the key insertion slot, in the rotor of the cylinder, said primary pins having a respective end which protrudes into said slot.

The primary pins are associated with respective complementary pins, which can move elastically from a configuration in which they are fully accommodated within the stator to at least one configuration in which they are accommodated simultaneously in the stator and in the rotor, consequently rigidly coupling these two parts.

The key is provided with a lever, which is accommodated so that it can rotate within a respective seat and which, when the key is inserted within the slot, actuates the primary pins, arranging them so that the complementary pins are in the configuration in which they are fully accommodated within the stator, allowing the rotor to move if said key is turned.

The presence of the lever in the key, associated with the at least two primary pins, ensures higher safety of the lock against effraction actions generically termed “picking” (mechanical tampering).

By using a suitable effraction tool which faithfully reproduces the orientable lever at the primary pins, it becomes possible to open the cylinder lock by using traditional mechanical tampering techniques and tools. In practice, an ill-intentioned person who is capable of producing a dedicated effraction tool for this type of cylinder lock can perform a mechanical tampering action whose difficulty of success is tied only to the decoding of the appropriate key profile.

### SUMMARY OF THE INVENTION

The aim of the present invention is to obviate the cited drawbacks and meet the mentioned requirements, by providing a cylinder lock and an associated key in which the correct profile of the lever cannot be reproduced easily.

Within this aim, an object of the present invention is to provide a structure which is simple, relatively easy to provide in practice, safe in use, effective in operation, and has a relatively low cost.

This aim and this and other objects which will become better apparent hereinafter are achieved by the present cylinder lock and associated key of the type which comprises primary pins which are substantially mutually opposite with respect to a longitudinal slot provided in the rotor of said cylinder and suitable for the insertion of said key, said primary pins being associated with respective movable complementary pins accommodated within respective rotor and stator passages provided at the surface of discontinuity formed between the stator and the rotor of said cylinder, and a key which is provided with a seat for accommodating a respective orientable lever, which is suitable to actuate said primary pins, characterized in that said lever has a thickness which can vary, even locally and discontinuously, with a substantially coded pattern, which depends on the geometry and arrangement of said primary pins which are substantially aligned therewith, forming a particular configuration of contact of the heads of said primary pins against the surface of said lever at which said complementary pins are completely accommodated within only one of the passages and therefore the stator and the rotor of said cylinder are mutually disengaged.

### BRIEF DESCRIPTION OF THE DRAWINGS

Further characteristics and advantages of the invention will become better apparent from the following detailed description of a preferred but not exclusive embodiment of a cylinder lock and of the associated key, illustrated by way of non-limiting example in the accompanying drawings, wherein:

FIG. 1 is a sectional side view, taken along a longitudinal plane, of a possible embodiment of a cylinder lock according to the invention, with the associated key inserted therein;

FIG. 2 is a sectional side view, taken along a longitudinal plane, of a possible embodiment of a cylinder lock according to the invention;

FIG. 3 is a sectional side view of a possible key according to the invention;

FIG. 4 is a sectional view taken along the line IV-IV of FIG. 1;

FIG. 5 is a sectional view taken along the line V-V of FIG. 2;

FIG. 6 is a sectional view taken along the line VI-VI of FIG. 1;

FIG. 7 is a sectional side view, taken along a longitudinal plane, of a possible embodiment of a cylinder lock according to the invention, with the associated key inserted therein;

FIG. 8 is a sectional view, taken along the line VIII-VIII of FIG. 7;

FIG. 9 is a sectional side view of a possible key according to the invention;

FIG. 10 is a sectional front view, taken along a transverse plane which passes through the movable element of the key, of a possible embodiment of a cylinder lock according to the invention, with the associated key inserted therein;

FIG. 11 is a sectional front view, taken along a transverse plane which passes through the movable element of the key, of a possible embodiment of a cylinder lock according to the invention, with the associated key inserted therein;

FIG. 12 is a sectional front view, taken along a transverse plane which passes through the movable element of the key, of a possible embodiment of a cylinder lock according to the invention, with the associated key inserted therein;

FIG. 13 is a sectional front view, taken along a transverse plane which passes through the movable element of the key, of a possible embodiment of a cylinder lock according to the invention, with the associated key inserted therein;

FIG. 14 is a sectional front view, taken along a transverse plane which passes through the movable element of the key, of a possible embodiment of a cylinder lock according to the invention, with the associated key inserted therein;

FIGS. 15a-15d are side views of some possible keys according to the invention;

FIGS. 16a-16d are sectional front views of some possible movable elements for keys according to the invention.

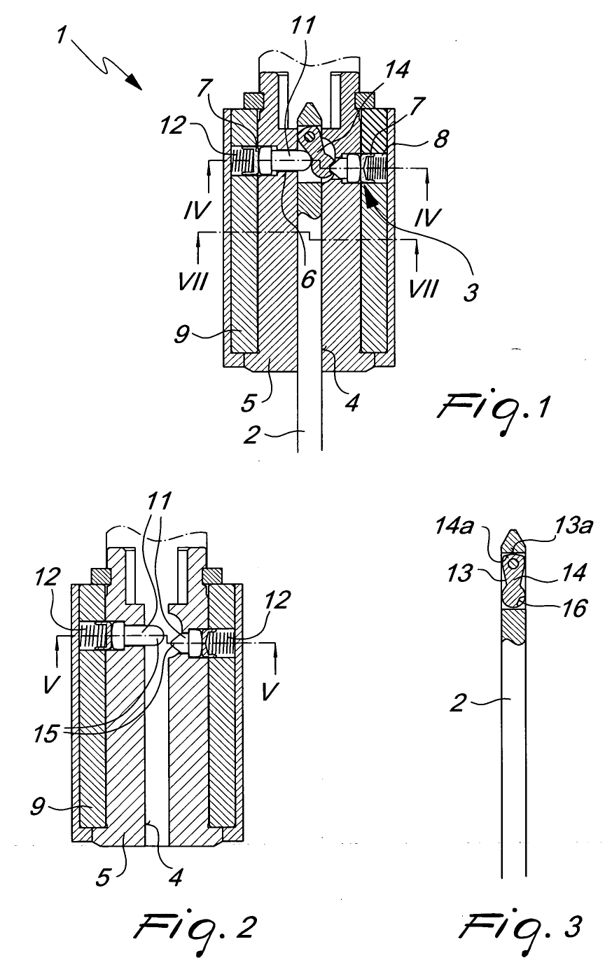

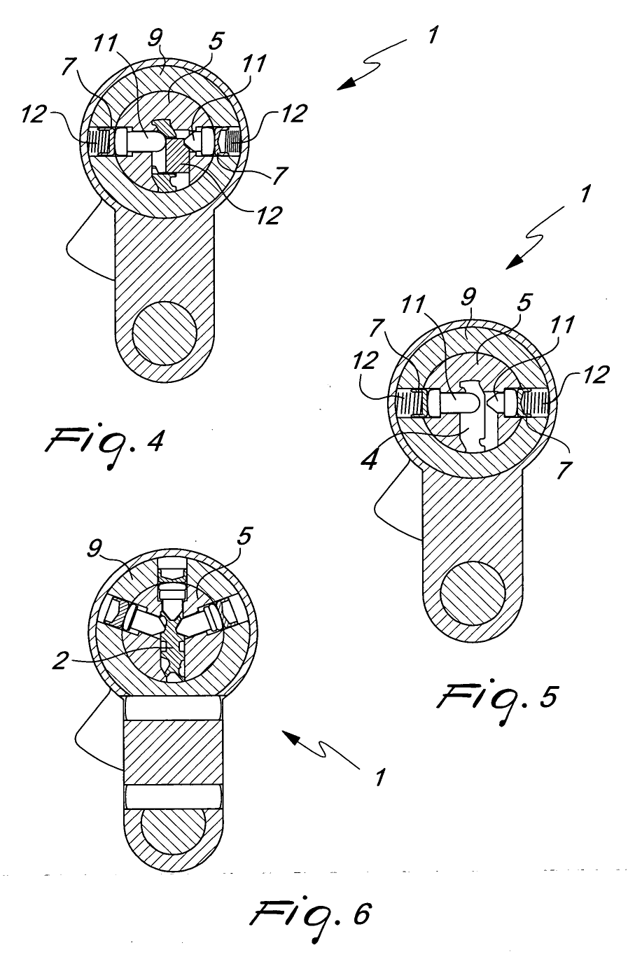

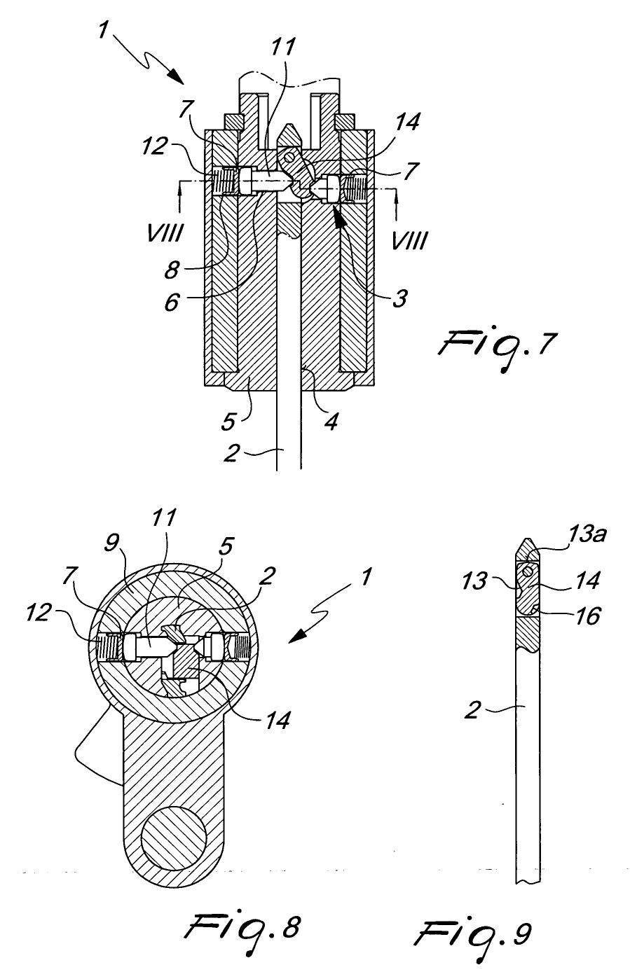

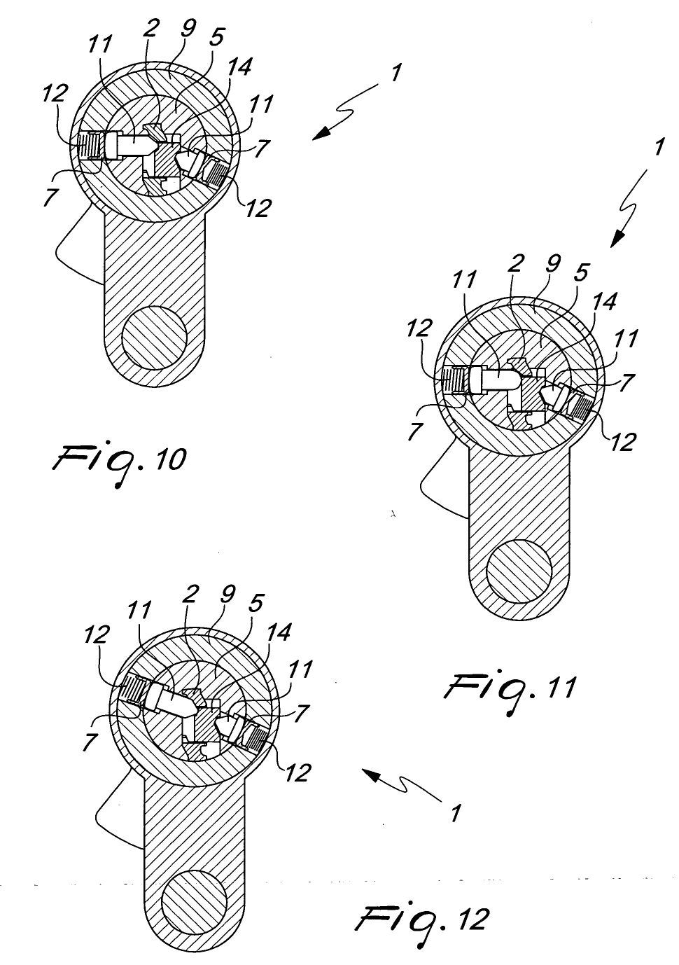

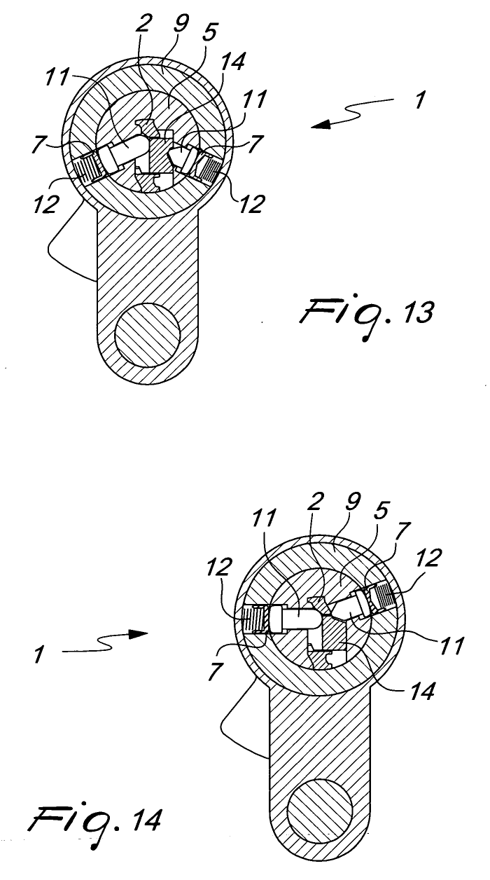

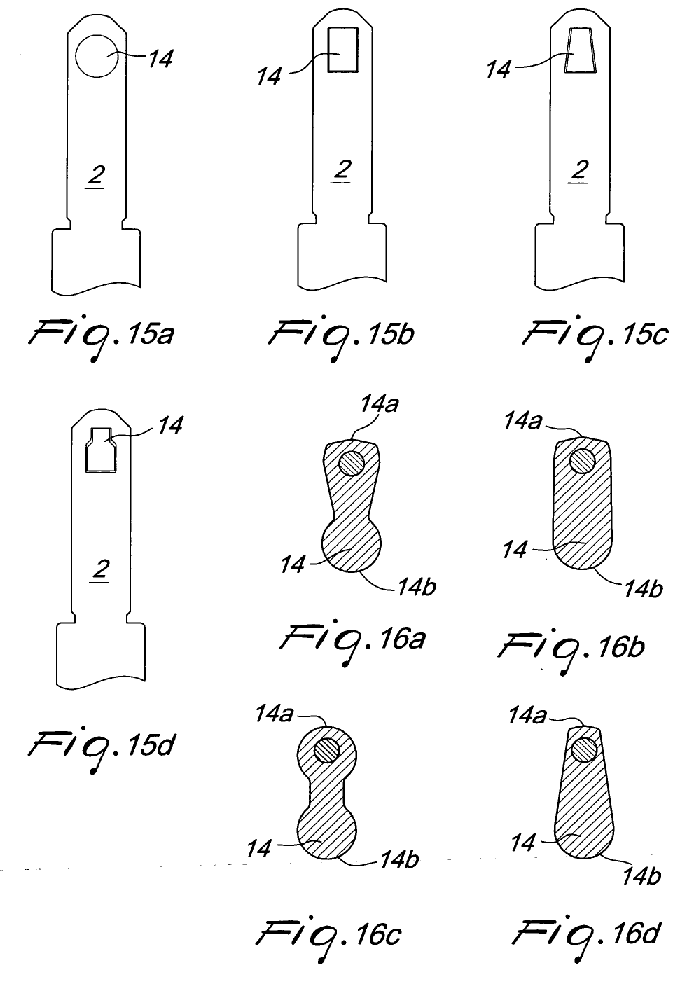

### DESCRIPTION OF THE PREFERRED EMBODIMENTS

With reference to the figures, the reference numeral 1 generally designates a cylinder lock and the reference numeral 2 generally designates an associated key.

The cylinder lock 1 comprises two primary pins 3, which are substantially mutually opposite with respect to a longitudinal slot 4 for the insertion of the key 2, which is provided in a rotor 5 of the cylinder 1: the primary pins 3 can move in the direction identified by their axis within a radial passage 6 of the rotor 5.

The primary pins 3 are aligned and rested against respective complementary pins 7, which can move (likewise in the common direction identified by their axis and by the axis of the primary pins 3) within the passage 6 and within a passage 8 of the stator 9.

The primary pins 3 are substantially cylindrical and are provided with a block 10 which has a larger diameter and is arranged (within the cylinder 1) externally (in a radial direction); the passage 6 is constituted by a first internal portion, whose diameter is slightly larger than the diameter of the internal cylindrical portion 11, and a second external portion, which has a slightly larger diameter than the block 10. The primary pin 3 can move toward the rotation axis of the rotor 5 until the block 10 reaches the surface of discontinuity between the first and second portions having different diameters of the passage 6: the primary pin therefore has a limited stroke, which depends on the height of the block 10 and on the depth of the second portion of the passage 6 having a larger diameter.

The passage 8 within which the complementary pins 7 can move has a diameter which is substantially identical to the diameter of the second portion of the passage 6, because the complementary pins 7 have a diameter which is similar to the diameter of the block 10.

The passage 8 is blind, and an axially-acting spring 12 is interposed between the respective complementary pin 7 and the bottom of the passage 8 and is intended to force toward the axis of the rotor 5 the respective complementary pin 7 and accordingly the primary pin 3 that is aligned with it and located proximate to it.

In the inactive condition, when the key 2 is not inserted within the channel 4, each complementary pin 7 is partially accommodated within the passage 8 and partially accommodated within the passage 6, while the primary pin is completely inserted within the passage 6 so that the block 10 rests against the surface of discontinuity between the first and second portions of the passage 6 by way of the action of the spring 12.

The key 2 is substantially flat and its length depends on the depth of the cylinder lock 1; the key 2 has a plurality of grooves and recesses (not shown in the figure), which are suitable for the insertion of portions of studs (in practice, other pins which are similar to the primary pins 3, arranged radially with respect to the cylinder 1) when it is inserted in the slot 4 of the lock 1. The studs, of a known type, cooperate directly or indirectly to their interposition between the rotor 5 and the stator 9, preventing relative rotations when the key is not inserted: the distribution and geometry of the grooves and recesses substantially constitutes the code of the key 2, which is suitable to ensure that the lock 1 to which it is dedicated cannot be opened by means of other keys 2 which have a different code.

The key 2 is further provided with a seat 13 for accommodating within its body cross-sectional thickness bulk a respective lever 14, which is substantially flat and is pivoted at a perimetric edge 14a thereof. The shape and dimensions of the seat 13 are complementary to the contour of the lever 14, so that its edge 14b (the edge that lies opposite with respect to the edge 14a arranged in the pivoting region) can oscillate, protruding from within the body profile of the key 2.

The lever 14 can be orientated in order to be able to actuate the primary pins 3 when the key is inserted within the slot 4 of the lock 1.

The lever 14 has a thickness which can vary, even discontinuously and only locally, according to a substantially coded pattern: the heads 15 of the primary pins 3 in fact rest against portions of the surface of the lever 14.

The pattern of the thickness and the location of the regions of the lever 14 in which it varies depend on the geometry of the primary pins 3 and are provided in order to define a particular configuration of contact of the heads 15 against the surface of the lever 14 at which the complementary pins 7 are accommodated completely within the passage 8 and therefore the stator 9 and the rotor 5 are mutually disengaged, allowing their mutual rotation.

It should be noted that the oscillation of the lever 14 within the seat 13 of the key 2 is limited as a consequence of the contact of the perimetric edge 14a which lies proximate to the pivoting axis against a respective surface 13a of the seat 13 which faces it and lies proximate thereto: in this manner, the lever 14 is prevented from assuming configurations which correspond to excessive rotations, which would not be matched by a correct placement of the primary pins 3 and of the complementary pins 7 and therefore by the disengagement of the rotor 5 from the stator 9.

From the embodiment described in FIG. 1, it can be seen that the lever is provided with suitable cavities 16 on its substantially opposite surfaces; the shape and dimensions of the cavities 16 are complementary to those of the head 15 of the respective primary pin 3.

The cavities 16 are distributed on the faces which are parallel to the pivoting axis, forming seats for the heads 15 of the primary pins 3, which in this configuration are substantially perpendicular to said faces.

The embodiment shown in FIG. 1, which has only two primary pins 3, can also be provided with a larger number of primary pins 3 in order to maximize the possibilities of coding of the lever 14, increasing the security of the lock 1 (effraction becomes more complicated, since the number of elements that the picker must tamper with in order to allow the rotation of the rotor 5 increases).

In the embodiment shown in FIG. 14, the cavities 16 are distributed also on one of the perimetric edge surfaces of the lever 14 which is substantially perpendicular to the pivoting axis, forming seats for the respective head 11 of the primary pin 3, which in this case is substantially inclined with respect to said axis.

It is possible to provide an embodiment (not shown in the figure) in which the lever 14 has a transverse hole which the respective primary pins 3 can enter completely: it is actually possible to provide small recesses, suitable to accommodate exclusively the heads 11, or to shape the lever 14 so that its edge has an irregular pattern and the primary pin 3 that corresponds to a given cross-section of the lever 14 acts on a portion having a predefined thickness in order to position it correctly, ensuring the opening of the lock 1.

The embodiments shown in the figures are merely some examples of how a lock 1 according to the invention can be provided; and all the possible combinations of the illustrated embodiments, combined with each other or with elements of the background art, are understood to be within the scope of the present invention.

The operation of the invention is intuitive: by inserting the key 2 within the slot 4 of the cylinder lock 1, all the studs that are present in the cylinder are arranged correctly on the respective plurality of grooves and recesses, disengaging the competent portion of the rotor 5 from the corresponding stator portion 9. When the key 2 is inserted, the lever 14 is interposed between the heads 11 of the primary pins 3, which are partially (or completely, depending on the manufacturing specifications) within the corresponding cavities 16: the lever 14 is kept inclined with respect to the axis of the key, since the action of one primary pin 3 is greater than the action of the primary pin 3 that lies opposite thereto, and in this manner the coupling between the heads 11 and the respective cavities 16 occurs only when the lever 14 is correctly kept inclined by the action applied to the pins 3 by elastic means such as the axially-acting springs 12 arranged outside the complementary pins 7.

When the pins 3 are in that position (forced by the action of the springs 12), the complementary pins 7 are accommodated completely within the slot or passage 8, and the stator 9 and the rotor 5 are disengaged. By turning the key 2 it is therefore possible to turn the rotor 5, correspondingly opening the lock 1.

If one uses a key 2 which is exactly identical to the one suitable to open a lock 1 but in which the cavities 16 are not present or are differently shaped and/or distributed, opening of the lock 1 is not allowed.

The main advantage of the lock 1 according to the invention is that it can ensure high safety against any effraction in relation to the coding of the surface of the lever 14.

Conveniently, the key 2 offers the advantage of being suitable also for opening (if it has the same distribution of the plurality of grooves and recesses) locks of the type disclosed in Patent for Industrial Invention No. 1235586 dated 6 Sep. 1989 in the name of the same Applicant, and the key 2 therefore demonstrates extremely high versatility. It has thus been shown that the invention achieves the intended aim and object.

The invention thus conceived is susceptible of numerous modifications and variations, all of which are within the scope of the appended claims.

All the details may further be replaced with other technically equivalent ones.

In the examples of embodiment described, individual characteristics, given in relation to specific examples, may actually be interchanged with other different characteristics that exist in other examples of embodiment.

Moreover, it is noted that anything found to be already known during the patenting process is understood not to be claimed and to be the subject of a disclaimer.

The embodiment of the present invention shall be carried out in the most scrupulous compliance with the statutory and regulatory provisions related to the products of the invention or correlated thereto and following any required authorization of the corresponding competent authorities, with particular reference to regulations related to safety, environmental pollution and health.

In practice, the materials used, as well as the shapes and the dimensions, may be any according to the requirements without thereby abandoning the scope of the protection of the appended claims.

The disclosures in Italian Patent Application No. BO2005A000381 from which this application claims priority are incorporated herein by reference.

What is claimed is:

1. In combination, a cylinder lock and an associated key, the lock comprising: a stator; a rotor rotatable in said stator; primary pins with heads thereof and which are located mutually opposite with respect to a longitudinal slot provided in the rotor that is adapted for insertion of the key; movable complementary pins aligned with said primary pins and accommodated within respective passages of the rotor and the stator, provided at a surface of discontinuity formed between the stator and the rotor of the lock; and the key comprising a seat; a respective orientable lever accommodated in said seat, said lever being adapted to actuate said primary pins of the lock; and wherein said key lever has a cross-sectional thickness which is variable, even locally and discontinuously, according to a substantially coded pattern, said coded pattern depending on a geometry and arrangement of said primary pins of the lock which are substantially aligned with the lever, whereby to form a particular configuration of contact of the heads of said primary pins against a surface of said lever at which said complementary pins are arranged completely accommodated within only one of said passages of the rotor, with the stator and the rotor of the lock being mutually disengaged.

2. The lock and key of claim 1, wherein said key lever has a substantially flat shape and is pivoted about a pivoting axis located at a perimetric edge thereof, within a said seat of the key which is shaped complementary with respect to a contour of said lever, so that an opposite edge of the lever is oscillatable, to protrude from a cross-sectional thickness bulk of the key.

3. The lock and key of claim 2, wherein said key lever is provided with suitable cavities on a same surface or on opposite surfaces thereof, said cavities having shapes and dimensions which are complementary to the heads of said primary pins that are installed in the rotor of the lock, substantially in alignment with said lever.

4. The lock and key of claim 3, wherein said cavities are located on surfaces of the lever which are parallel to the pivoting axis, forming seats for the heads of at least two primary pins which are variously inclined with respect to said surfaces.

5. The lock and key of claim 3, wherein said cavities are distributed along perimetric edge surfaces of the lever that are perpendicular to the pivoting axis, forming seats for the heads of the at least two primary pins which are variously inclined with respect to said pivoting axis.

6. The lock and key of claim 1, comprising respective elastic means suitable to force inward said complementary pins and said primary pins, said elastic means being provided within one of said passages of the stator that accommodates said complementary pins, in a position which lies radially further outward with respect to said complementary pins.

7. The lock and key of claim 6, wherein said elastic means are axially-acting springs with different yielding, for providing different inward forcing of one primary pin with respect to another, with the key and therefore the lever interposed, keeping the lever in a predefined extreme rotation configuration which is suitable to disengage the rotor and the stator.

8. The lock and key of claim 1, comprising at least three primary pins and complementary pins, two of which are arranged substantially parallel to each other.

9. The lock and key of claim 3, wherein oscillation of said lever within said seat of the key is limited as a consequence of a contact of a perimetric edge of the lever which lies proximate to the pivoting axis against a respective facing and proximate surface of said seat.
